(19) United States
(12) Patent Application Publication
(10) Pub. No.: US 2025/0059373 A1
(43) Pub. Date: Feb. 20, 2025

(54) MULTIFUNCTIONAL ADDITIVE COMPOSITION FOR ASPHALTS

(71) Applicant: C.I MULTISERVICIO DE INGENIERIA 1A S.A, Barrancabermeja (CO)

(72) Inventors: Nilson AHUMADA ANGEL, Barrancabermeja (CO); Robinson HERNANDEZ ROA, Bogotá (CO); Neils LEAL, Barrio La Libertad Barrancabermeja (CO)

(21) Appl. No.: 18/719,244

(22) PCT Filed: Dec. 13, 2022
(86) PCT No.: PCT/IB2022/062158

§ 371 Date: Jun. 12, 2024

(30) Foreign Application Priority Data
Dec. 13, 2021 (CO) NC2021/0016867

(51) Int. Cl. C08L 95/00; C08K 5/5419; C08K 5/544; C08L 91/00

(52) U.S. Cl. CPC C08L 95/00; C08K 5/5419; C08K 5/544; C08L 91/00; C08L 2207/322; C08L 2555/74; C08L 2555/82

(57) ABSTRACT

The present invention refers to a multifunctional asphalt additive composition comprising a hydrocarbon base oil, an adhesion promoter, and naturally occurring resins. In particular, the hydrocarbon base oil comprises paraffinic or aromatic compounds, the adhesion promoter comprises aromatic, amine, acrylic, and straight or branched chain organosilane derivatives, and the naturally occurring resins comprise tannins, terpenes, and rosin. The multifunctional additive composition of the present invention is useful in the manufacture of asphalt mixtures, as a rejuvenation agent, in the recycling of asphalt mixtures, or as an additive to provide or improve one or more of the properties of low quality asphalts or those that do not meet the standards required for certain applications.

### TECHNICAL FIELD OF THE INVENTION

The invention pertains to the field of engineering materials related to asphalt additives, asphalt compositions, and products made from such asphalt additives. In particular, the present invention refers to a multifunctional asphalt additive composition comprising a hydrocarbon base oil, an adhesion promoter, and naturally occurring resins. The multifunctional asphalt additive of the present invention inhibits the aging rate, improves the softening point and penetration grade, improves viscosity and adhesion, delays oxidation, and prevents thermal degradation of asphalt.

### DESCRIPTION OF THE PRIOR ART

Asphalt is a very versatile material and is of great importance in the construction industry thanks to its consistency, adhesiveness, impermeability, and durability. It is mainly used in paving roads, driveways, and parking lots, mixed with an aggregate comprising stone, gravel, sand, and other additives.

The strength and durability of asphalt pavements depend on several factors, including the characteristics of the asphalt used and the materials used as aggregate, as well as the interaction with those materials with the asphalt, the mixture design, and the construction practices. In general, to produce a mixture that will perform well over the life of the pavement, it is important to have an adequate overlay of the aggregates with the asphalt, which is achieved with good adhesion between the asphalt and the aggregates without reducing the adhesion strength of the asphalt and with an appropriate thickness of the asphalt film on said aggregates. Furthermore, it is important to avoid deterioration of the pavement due to permanent deformation, fatigue cracking, or low temperature cracking, as well as deterioration caused by moisture.

Some methods to improve pavement durability include optimizing asphalt film thickness by increasing asphalt content and proper selection of aggregate particle size, proper compaction of the asphalt mixture so that a maximum void ratio of about 8% is achieved, and designing mixtures with dense particle sizes of impermeable aggregates.

However, sometimes it is not possible to ensure good pavement performance because the characteristics of certain asphalts do not allow a good asphalt mixture to be obtained. In addition, in some cases, aging phenomena occur in the asphalt due to high temperatures, the presence of oxygen, and UV radiation. Aging usually results in hardening of the asphalt, which causes premature wear and even cracking of the asphalt pavement.

Therefore, various products have been developed to improve some properties of asphalt and, thus, of asphalt mixtures. For example, with the aim of recovering some of the properties of aged asphalt, in particular its adhesive properties, patent US20160376440 discloses an asphalt additive wherein the active component of the additive is composed of a hydrocarbon log chain with amine functionality at the opposite end and wherein the asphalt additive further comprises crude tall oil and one or more vegetable oils.

On the other hand, patent EP2487207 discloses an anti-aging additive for asphalt wherein the additive contains free radical scavengers derived from an extract prepared from grape marc subjected to a special process for a dry powder that maintains the properties of free radical scavengers originally found in grapes, which prevents the degradation of asphalt caused by UV radiation and the presence of oxygen.

Finally, U.S. Pat. No. 8,741,052 discloses an additive for asphalts that can modify the adhesion and cohesion properties of asphalt by improving heat and moisture resistance. The additive comprises a combination of surfactants and a rheology modifier, wherein the Surfactant component preferably comprises at least an amine or modified amine surfactant, while the rheology modifying component comprises at least one of i) a wax component, ii) a non-asphalt soluble, non-meltable component, and iii) a resin component.

However, these additives generally only improve one property of asphalts at a time, either by improving the adhesion capacity of the asphalt (from viscosity reduction) or by reducing aging processes. Thus, for example, many additives to improve the adhesion capacity of asphalt cause a decrease in the viscosity of the mixture, negatively affecting the softening and penetration grades. Consequently, there is still a need to develop additives that can simultaneously improve several of the properties of asphalt that for various reasons do not allow good quality asphalt mixtures to be obtained, while providing protection against aging.

### SUMMARY OF THE INVENTION

In a first aspect, the present invention refers to a multifunctional asphalt additive composition comprising a hydrocarbon base oil from 60% w/w to 95% w/w; an adhesion promoter from 1% w/w to 10% w/w; and naturally occurring resins from 10% w/w to 20% w/w.

In a second aspect, the multifunctional additive composition is characterized in that the hydrocarbon base oil is selected from the group comprising paraffinic compounds, such as light, medium, and heavy paraffinic distillates, and aromatic compounds.

In a third aspect, the multifunctional additive composition is characterized in that the hydrocarbon base oil comprises paraffinic compounds from 30% w/w to 50% w/w or aromatic compounds from 20% w/w to 50% w/w, or mixtures thereof.

In a fourth aspect, the multifunctional additive composition is characterized in that the adhesion promoter comprises organosilane derivatives such as aromatic, amine, acrylic, and straight or branched chain silanes, and mixtures thereof.

In a fifth aspect, the multifunctional additive composition is characterized in that the naturally occurring resins comprise tannins, terpenes, and rosin.

In a sixth aspect, the multifunctional additive composition is characterized in that it comprises other non-aggregate additives from 0.1% w/w to 5% w/w.

Wherein non-aggregate additives are selected from low vapor pressure fluxing agents, oxidation inhibitors, rheology modifiers, surfactant homogenizers, and mixtures thereof.

In a seventh aspect, the multifunctional additive composition is characterized in that it comprises, before aging, a penetration grade at 25° C. between 40 and 100 ( 1/10 mm); viscosity at 60° C. between 1,000 and 8,000 (Poises); a softening point between 45 and 54 (° C.); and, after aging, a penetration grade at 25° C. between 30 and 60 ( 1/10 mm); viscosity at 60° C. between 3,000 and 10,000 (Poises); a softening point between 53 and 60 (° C.); an aging rate between 1 and 4; a mass loss between 0.1 and 1(%); an increase in the softening point between 1 and 8 (° C.); and a penetration of the residue between 46 and 60(%).

In an eighth aspect, the present invention refers to the use of the multifunctional additive composition in the transformation of asphalts that do not meet the aging rate for subsequent application.

### BRIEF DESCRIPTION OF THE DRAWINGS

FIG. 1 Granulometric curve of the stone material recovered from a standardized asphalt mixture from Apiay with conventional additive composition A-5. The figure shows that the stone material obtained from the extraction complies with the granulometric range provided in Article 540-13 of INVIAS-13 specification, wherein the solid line refers to the quantities retained in each sieve of the asphalt mixture sample and the dashed lines refer to the ranges that the asphalt mixture must meet for each sieve along the curve.

FIG. 2. Plastic deformation resistance on a track of a standardized asphalt mixture from Apiay with additive composition A-5. The figure shows that initially there is a high deformation rate and as time passes this deformation rate decreases noticeably, obtaining a deformation rate value of 2.8 μm in the interval from 105 min to 120 min. This result complies with the maximum allowed (15 μm) by Article 450-13, Table 450-11, of the specification.

FIG. 3. Dynamic moduli as a function of frequency and temperature of a standardized asphalt mixture from Apiay with additive composition A-5. Based on the Tensile Strength Ratio (TSR) test and considering that this test is not destructive, it is possible to evaluate the incidence of temperature on the dynamic behavior of the asphalt mixture by testing at temperatures in a set temperature range. In this case, for the selected samples, dynamic moduli are carried out at three (3) frequencies (1.5 Hz; 5 Hz, and 10 Hz) and at three (3) temperatures (5° C., 25° C., and 40° C.), performing measurements on two sides of each sample; average values of 12 km/h, 40 km/h, and 80 km/h were obtained.

### DETAILED DESCRIPTION OF THE INVENTION

The terms used throughout this document should be understood as their usual meaning in the technical field unless a particular definition is provided or the context clearly indicates otherwise. Additionally, terms used in the singular form shall also include the plural form.

Unless otherwise specified, implicitly from the context or as it is usual in the art, all parts and percentages in this Specification are based on weight.

For the purposes of the present invention, “asphalt” is defined as the residual fraction resulting from the fractional distillation of petroleum, also known as asphalt binder, and “asphalt mixture” is defined as a mixture of asphalt, stone aggregates, and other additives used in road paving. “Additives” are defined as chemical substances that are used to improve certain specific properties of asphalt before being incorporated into the preparation of the asphalt mixture.

Asphalt is a thermoplastic compound derived from the refining of crude oil. In particular, asphalt is a complex mixture of hydrocarbons composed of a heavy fraction of asphaltenes with molecular weights that range between 4,000 and 7,000 and a light fraction of maltenes with molecular weights that range from 700 to 4,000. The maltenic fraction contains in turn a fraction of kerosenes with weights that range from 600 to 1,000, a fraction of resins with weights that range from 1,000 to 2,000, and a fraction of aromatic oils with weights that range from 2,000 to 4,000. The components of each asphaltene and maltene fraction interact with each other to form a viscoelastic fluid.

Asphalt mixtures are widely used in road construction and maintenance and are generally produced by mixing asphalt with stone material and other additives at a temperature between 130° C. and 160° C. in defined proportions according to the expected conditions of use and performance. The strength and durability of asphalt mixtures depend on several factors including the properties of the materials used (asphalts, stone material, and other additives), the interaction of the materials, the mixture design, and the manufacturing method, among others. In particular, the quality of the asphalt used to prepare the mixture is a determining factor in the final quality of the pavement because it is the element that binds the other components of the mixture. The asphalt must provide a coating film on the aggregates that produces good adhesion and sufficient resistance to the cohesion of the asphalt mixture and consequently of the pavements. Adhesion is the formation of chemical bonds between the asphalt and aggregates allowing all elements to stay together, while cohesion is the interaction between the asphalt films coating the aggregates.

However, asphalt mixtures deteriorate over time due to the impact of traffic, water, and sunlight. This deterioration of pavement quality leads to permanent deformation or rutting, cracking or embrittlement, and reduced skid resistance. This deterioration becomes evident when, for example, a decrease in the penetration grade and an increase in the softening point are observed.

There are some methods to improve the durability of asphalt mixtures which include maximizing the thickness of the asphalt film by increasing the asphalt content and adequate particle size and selection of aggregates; compacting the asphalt mixture so that a maximum void percentage of around 8% is reached; designing mixtures with dense particle sizes of impermeable aggregates; and adding components that raise the viscosity of the asphalt, which increases the thickness of the film that surrounds the aggregates, thus reducing the aging process of the bitumen and, consequently, improving the durability and the performance of asphalt mixtures.

One of the main characteristics of the asphalt aging process is an increase in viscosity that results in a hardening of the material. Aging processes can be physical, chemical, or both. The chemical aging process is mainly due to the loss of volatile components and hardening of the asphalt and is inherently irreversible. It is presumed that this process occurs by the interaction of oxygen with some highly reactive hydrocarbon compounds, initially producing cyclic aromatic compounds and subsequently producing polar carbonyl compounds such as ketones and carboxylic acids that tend to associate or polymerize, producing complex molecules of high molecular weight, which increases the fraction of asphaltenes and also the viscosity of the asphalt.

On the other hand, the physical aging process takes place due to a rearrangement of molecules to reach an optimal thermodynamic state under a specific set of conditions and, consequently, this process is reversible.

In this sense, several methods have been developed to recover some of the properties of asphalt that are lost during use without the need to replace the entire asphalt mixture, and other methods to improve the properties of asphalts that do not meet the standards required for their use in any of their multiple applications. For example, refinery asphalts sometimes cannot be applied directly to asphalt mixtures because they do not meet the standards of the National Roads Institute of Colombia (INVIAS) since they have a high content of asphaltenes and resins, which make them susceptible to deterioration in a short time due to oxidation and chemical degradation.

The first methods used are essentially recycling of asphalt mixtures, which aim to reduce the demand for natural resources, decrease the production of waste material, and, therefore, reduce costs. Their main focus is to partially recover one or more of the properties of the original asphalt mixture.

Other methods instead aim to provide or improve one or more of the desired properties of the asphalt so that it can be used in applications where it would not otherwise meet the minimum required standards.

The multifunctional additive composition of the present invention can be employed as a rejuvenation agent to provide or improve various properties in low quality asphalts.

For the purposes of the present invention, the multifunctional asphalt additive composition comprises a hydrocarbon base oil from 60% w/w to 80% w/w, from 60% w/w to 70% w/w, from 70% w/w to 80% w/w, from 65% w/w to 75% w/w, or from 65% w/w to 80% w/w, from 75% w/w to 80% w/w, or from 75% w/w to 80% w/w.

For the purposes of the present invention, hydrocarbon base oil comprises paraffinic or aromatic compounds and mixtures thereof.

Wherein the paraffinic compounds are present from 30% w/w to 50% w/w, from 30% w/w to 40% w/w, from 40% w/w to 50% w/w, from 35% w/w to 45% w/w, from 35% w/w to 50% w/w, from 35% w/w to 40% w/w, or from 45% w/w to 50% w/w.

Wherein paraffinic compounds comprise light, medium, and heavy paraffinic distillates and blends thereof.

Wherein the light paraffinic distillates are selected from, among others, one or more of the group comprising methane, ethane, propane, and butane; wherein the medium paraffinic distillates are selected from, among others, one or more of the group comprising pentane, hexane, heptane, and octane; and wherein the heavy paraffinic distillates are selected from, among others, one or more from the group comprising heptadecane, octadecane, and compounds of general formula CₙH₂ₙ+2, wherein n>17. Wherein, preferably, the paraffinic distillates are selected from pentane, hexane, octane, and compounds of general formula CₙH₂ₙ+2, wherein 25>n>17.

Wherein the aromatic compounds are from 20% w/w to 50% w/w, or from 20% w/w to 35% w/w, or from 35% w/w to 50% w/w, or from 35% w/w to 45% w/w, or from 45% w/w to 50% w/w, or from 20% w/w to 30% w/w, or from 20% w/w to 35% w/w, or from 30% to 40% w/w, or from 35% w/w to 40% w/w, or from 40% w/w to 50% w/w, or from 30% w/w to 50% w/w, or from 20% w/w to 40% w/w, or from 20% w/w to 25% w/w, or from 25% w/w to 35% w/w, from 25% w/w to 30% w/w, or from 25% w/w to 45% w/w.

Wherein the aromatic compounds comprise benzene, toluene, o-, m-, p-xylene, indene, naphthalene, biphenyl, anthracene, or mixtures thereof.

For the purposes of the present invention, the multifunctional asphalt additive composition comprises an adhesion promoter from 1% w/w to 10% w/w, from 1% w/w to 5% w/w, from 5% w/w to 10% w/w, from 1% w/w to 2.5% w/w, from 5% w/w to 7.5% w/w, from 2.5% w/w to 7.5% w/w, from 2.5% w/w to 5% w/w, or from 7.5% w/w to 10% w/w.

Wherein the adhesion promoter comprises aromatic, amine, acrylic, and straight or branched chain organosilane derivatives and mixtures thereof.

Wherein the aromatic organosilane derivatives are selected from, among others, one or more of the group comprising (3-aminopropyl)-triethoxysilane (APTES), N-phenyl-3-aminopropyltrimethoxy silane, diphenyldimethoxy silane, phenyltriethoxy silane, or mixtures thereof. In one embodiment of the invention, the aromatic organosilane derivatives are selected from (3-aminopropyl)-triethoxysilane (APTES) and aminopropyltrimethoxy silane.

Wherein the amine organosilane derivatives are selected from, among others, one or more of the group comprising N-(3-(trimethoxysilyl)propyl)butylamine, 3-aminopropyltriethoxysilane, 3-(aminopropyl)trimethoxy silane, 3-aminopropyl methyl dimethoxy silane, N-(β-aminoethyl)-γ-aminopropyl-methyl dimethoxy silane, 2-ethanediamine, N-(2-aminoethyl)-N-[3-(trimethoxysilyl)propyl], (N,N-diethyl-3-aminopropyl) trimethoxysilane, and mixtures thereof. In one embodiment, the organosilane amine derivative is 3-aminopropyl methyldimethoxysilane.

Wherein the acrylic organosilane derivatives are selected from, among others, one or more of the group comprising 3-(dimethoxy methyl silyl)propyl methacrylate, 3-[tris(trimethylsiloxy)silyl]propyl methacrylate, 3-methacryloxy propyl trimethoxy silane, 3-methacryloxypropyl methyl dimethyloxy silane, and mixtures thereof. In one embodiment of the invention, the acrylic organosilane derivatives are preferably 3-(dimethoxymethylsilyl)propyl methacrylate, 3-methacryloyloxypropyltrimethoxysilane, 3-methacryloyloxypropylmethyldimethyldimethyloxysilane.

Wherein the straight or branched chain organosilane derivatives are selected from, among others, one or more of the group comprising triethoxy propylsilane, diethoxy dimethylsilane, dodecyl triethoxy silane, N-dodecyl trimethoxy silane, n-hexadecyl trimethoxy silane, trimethoxy-n-octylsilane, triethoxyoctylsilane, or mixtures thereof. In one embodiment of the invention, the straight or branched chain organosilane derivatives are triethoxy, propylsilane, N-dodecyltrimethoxy silane, or n-hexadecyltrimethoxysilane.

For the purposes of the present invention, the multifunctional asphalt additive composition comprises naturally occurring resins from 10% w/w to 20% w/w, from 10% w/w to 15% w/w, from 15% w/w to 20% w/w, from 10% w/w to 12.5% w/w, from 12.5% w/w to 20% w/w, from 12.5% w/w to 15% w/w, from 15% to 17.5% w/w, from 12.5% w/w to 17.5% w/w, or from 17.5% w/w to 20% w/w.

Wherein the naturally occurring resins comprise tannins, terpenes, rosin, and mixtures thereof. In one embodiment of the invention, the naturally occurring resin is rosin. Particularly, for the purposes of the present invention, the rosin comprises naturally occurring rosins consisting of resin acids including one or more of the group comprising abietic acid, abieta-7,13-dien-18-oic acid, 13-isopropylpodocarpa-7,13 acid. -dien-15-oic acid, neoabietic acid, dehydroabietic acid, palustric acid, levopimaric acid, pimaric acid, isopimaric acid, and mixtures thereof.

Wherein the tannins are selected from, among others, one or more of the group comprising 3,4,5-trihydroxybenzoic acid, proanthocyanidins, pterocaryanin C, casuarictin, procyanidin B1, proguibourtinidin, phlorotannins, tetrafucol, 6,6′-biecol, and mixtures thereof. In one embodiment, the tannin is 3,4,5-trihydroxybenzoic acid, proanthocyanidins, phlorotannins, tetrafucol, and mixtures thereof.

Wherein the terpenes are selected from, among others, one or more of the group comprising turpentine, pinene, myrcene, camphene, arene, phytol, squalene, latex, vitamin A, and mixtures thereof. In one embodiment, the terpene is pinene, myrcene, camphene, turpentine, and mixtures thereof.

For the purposes of the present invention, the multifunctional additive composition is characterized in that it comprises other non-aggregate additives from 0.1% w/w to 5% w/w, from 0, % w/w to 0.5% w/w, from 0.5% w/w to 1% w/w, and from 1% w/w to 5% w/w. Non-aggregate additives are selected from low vapor pressure fluxing agents, oxidation inhibitors, viscosifiers, stabilizers, and mixtures thereof.

For the purposes of the present invention, the multifunctional additive composition can be prepared by different methods known in the art, which in general terms comprise any equipment that allows the homogenization of the mixture of naturally occurring resin in aromatic oils, paraffinic base, and by the adhesion promoter and the control of the conditions of temperature, agitation, and optionally pressure.

For the purposes of the present invention, the multifunctional additive composition is characterized by having, before aging, a penetration grade at 25° C. between 40 and 100 ( 1/10 mm); viscosity at 60° C. between 1,000 and 8,000 (Poises); a softening point between 45 and 54 (° C.); and, after aging, a penetration grade at 25° C. between 30 and 60 ( 1/10 mm); viscosity at 60° C. between 3,000 and 10,000 (Poises); a softening point between 53 and 60 (° C.); an aging rate between 1 and 4; a mass loss between 0.1 and 1(%); an increase in the softening point between 1 and 8 (° C.); and a penetration of the residue between 46 and 60(%).

The multifunctional additive composition of the present invention is useful in the manufacture of asphalt mixtures, as a rejuvenation agent, in the recycling of asphalt mixtures, or as an additive to provide or improve one or more of the properties of low quality asphalts or those that do not meet the standards required for certain applications. In particular, the additive composition of the present invention increases various properties of the asphalt without altering the other physicochemical properties of the asphalt.

The present invention will be presented in detail through the following examples, which are provided for illustrative purposes only and not with the aim of limiting its scope.

### EXAMPLES

### Example 1: Preparation of Multifunctional Additive Compositions

Additive composition A-1 was prepared by mixing in a container 90 g of a hydrocarbon base oil characterized by 40% paraffinic compounds and 60% aromatic compounds with 10 g of (3-aminopropyl)-triethoxysilane (APTES) as adhesion promoter at a temperature of 30° C. for 3 h.

Following the same preparation procedure described for additive composition A1, additive compositions A-2 to A-5 were prepared changing the type and concentration of the hydrocarbon base oil, the adhesion promoter, and the vegetable resin as shown in Table 1.

TABLE 1
Multifunctional additive compositions

| | Components | | | | | |
|---|---|---|---|---|---|---|
| Additive | Hydrocarbon | | Adhesion | | Vegetable | |
| composition | base oil | (% w/w) | promoter | (% w/w) | resin | (% w/w) |
| A-1 | Mixture of 25% | 90 | (3-aminopropyl)- | 10 | — | — |
| | benzene and | | triethoxysilane | | | |
| | 15% toluene | | (APTES) | | | |
| | Mixture of 10% | | | | | |
| | pentane, 20% | | | | | |
| | hexane, and | | | | | |
| | 30% heptane | | | | | |
| A-2 | 40% toluene | 95 | (3-aminopropyl)- | 5 | — | — |
| | 60% heptane | | triethoxysilane | | | |
| | | | (APTES) | | | |
| A-3 | Mixture of 25% | 70 | N-dodecy1 | 30 | — | — |
| | benzene and | | trimethoxysilane | | | |
| | 25% toluene | | | | | |
| | Mixture of 15% | | | | | |
| | pentane, 15% | | | | | |
| | hexane, and | | | | | |
| | 20% heptane | | | | | |
| A-4 | — | — | (3-aminopropy1)- | 20 | Mixture of | 80 |
| | | | triethoxysilane | | 33% 13- | |
| | | | (APTES) | | isopropylpod | |
| | | | | | ocarpa-7,13- | |
| | | | | | dien-15-oic | |
| | | | | | acid, 33% | |
| | | | | | neoabietic acid. | |
| | | | | | dehydroabietic | |
| | | | | | acid, and 34% | |
| | | | | | palustric acid | |
| A-5 | Mixture of | 80 | (3-aminopropy1)- | 5 | Mixture of | 15 |
| | 20% benzene, | | triethoxysilane | | 33% abietic | |
| | 40% toluene, | | (APTES) | | acid, 33% | |
| | 15% pentane, | | | | abieta-7,13- | |
| | 15% hexane, | | | | dien-18-oic | |
| | 10% heptane | | | | acid, and 34% | |
| | | | | | 13-isopropylpod | |
| | | | | | ocarpa-7,13- | |
| | | | | | dien-15-oic | |
| | | | | | acid | |

### Example 2. Performance Evaluation of Additive Compositions

To determine the performance of the multifunctional additive composition of the present invention when it is added to asphalt, performance analyses of additive compositions A-1 through A-5 were performed as described in Example 1.

The analysis of the performance of additive compositions A-1 to A-4 was carried out by adding 0.25% w/w to 1% w/w of the additive composition to 31,000 kg of an asphalt derived from heavy crude oils from the Apiay refinery. This asphalt was chosen because it has high dynamic viscosity (P) s 60° C. according to INVIAS E-716 standard (Table 410). Therefore, it does not meet the specifications of the national standards, in particular INVIAS E-717 standard (Table 410) regarding the aging rate.

On the other hand, the analysis of the performance of additive composition A-5 was carried out by adding 0.75% w/w of the additive composition to 31,000 kg of asphalt from the Barrancabermeja refinery, which meets INVIAS standards as it is derived from light crude oils found in the region.

In both cases, the tests were carried out before and after subjecting the asphalt with additive to aging using the Rolling Thin Film Oven Test (RTFOT), which consists of indicating the estimated change in the properties of the asphalt or asphalt mixture during the hot mixing process at temperatures of approximately 150° C. by measuring penetration, viscosity, or ductility. With the above process, the asphalt or asphalt mixture approaches the condition of asphalt when incorporated into the pavement.

The first step of this test is weighing the containers with and without the mixture and leveling the oven. Then, the containers with the asphalt mixture are quickly placed on the circular shelf at 163+° C. and the rotation of the shelf is started. When the rotation has finished, the containers are removed and left at rest. Finally, the containers are weighed and samples are taken for the penetration and softening point tests (ring and ball).

Tables 2 to 5 show the results of the performance tests of additive compositions 2 to 5 added to the asphalt coming from the Apiay refinery.

TABLE 2
Performance of composition A-1 added to asphalt derived from heavy crude oils.
Apiay 60/70 asphalt

| | INVIAS | Specification | | Standardized | A-1 (%) | |
|---|---|---|---|---|---|---|
| Assay | standard | Minimum | Maximum | Apiay | 0.8 | 1 |

Before aging

| | | | | | | |
|---|---|---|---|---|---|---|
| Penetration at 25° C. (1/10 mm) | INV E-706 | 60 | 70 | 71.9 | 72.7 | 74.7 |
| Viscosity at 60° C. (Poises) | INV E-717 | 1,500 | — | 1,830 | 1,660 | 1,730 |
| Softening point (° C.) | INV E-712 | 48 | 54 | 46.3 | 46.1 | 46 |

After aging in *RTFOT

| | | | | | | |
|---|---|---|---|---|---|---|
| Penetration at 25° C. (1/10 mm) | INV E-706 | — | — | 37.8 | 40.8 | 37.8 |
| Viscosity at 60° C. (Poises) | INV E-717 | — | — | 14,500 | 12,840 | 12,400 |
| Softening point (° C.) | INV E-712 | — | — | 56.9 | 57.5 | 58 |
| Aging rate | INV E-717 | — | 4 | 7.92 | 7.73 | 7.17 |
| Mass loss (%) | INV E-720 | — | 0.8 | 0.31 | 0.45 | 0.42 |
| Softening point increase (° C.) | INV E-712 | — | 9 | 10.6 | 11.4 | 12 |
| Residue penetration (%) | INV E-706 | 50 | — | 52.6 | 56.1 | 50.6 |

*Rolling thin film oven test.

As can be seen in the data in Table 2, the behavior of some of the physicochemical properties evaluated for the standardized Apiay asphalt does not meet the specifications of the INVIAS standard; therefore, the purpose of adding the additive composition A-1 in different percentages is to improve these results until they meet the specifications of the standard. However, in this case, there are no significant improvements in the physicochemical properties evaluated for the asphalts with percentages from 0.8% to 1%.

TABLE 3
Performance of composition A-2 added to asphalt derived from heavy crude oils.
Apiay 60/70 asphalt

| | INVIAS | Specification | | Standardized | A-2 (%) | |
|---|---|---|---|---|---|---|
| Assay | standard | Minimum | Maximum | Apiay | 0.375 | 0.5 |

Before aging

| | | | | | | |
|---|---|---|---|---|---|---|
| Penetration at 25° C. (1/10 mm) | INV E-706 | 60 | 70 | 71.9 | 68.3 | 69.6 |
| Viscosity at 60° C. (Poises) | INV E-717 | 1,500 | | 1,830 | 2,130 | 2,110 |
| Softening point (° C.) | INV E-712 | 48 | 54 | 46.3 | 48 | 48.5 |

After aging in *RTFOT

| | | | | | | |
|---|---|---|---|---|---|---|
| Penetration at 25° C. (1/10 mm) | INV E-706 | — | — | 37.8 | 40.2 | 40.4 |
| Viscosity at 60° C. (Poises) | INV E-717 | — | — | 14,500 | 12,600 | 13,300 |
| Softening point (° C.) | INV E-712 | — | — | 56.9 | 58.3 | 58.7 |
| Aging rate | INV E-717 | — | 4 | 7.92 | 5.92 | 6.30 |
| Mass loss (%) | INV E-720 | — | 0.8 | 0.31 | 0.31 | 0.33 |
| Softening point increase (° C.) | INV E-712 | — | 9 | 10.6 | 10.3 | 10.2 |
| Residue penetration (%) | INV E-706 | 50 | — | 52.6 | 58.9 | 58.0 |

*Rolling thin film oven test.

The behavior of additive composition A-2 in Apiay asphalt in the two tested percentages shows a remarkable improvement in the physicochemical properties before the aging test in RTFOT, thus meeting the required specifications. However, after aging, there is a very slight improvement in the properties evaluated (penetration at 25° C., viscosity at 60° C., aging rate, and softening point increase), which is not enough to meet all the required specifications.

TABLE 4
Performance of composition A-3 added to asphalt derived from heavy crude oils.
Apiay 60/70 asphalt

| | INVIAS | Specification | | Standardized | A-3 (%) | |
|---|---|---|---|---|---|---|
| Assay | standard | Minimum | Maximum | Apiay | 0.25 | 0.33 |

Before aging

| | | | | | | |
|---|---|---|---|---|---|---|
| Penetration at 25° C. (1/10 mm) | INV E-706 | 60 | 70 | 71.9 | 73.8 | 68 |
| Viscosity at 60° C. (Poises) | INV E-717 | 1,500 | — | 1,830 | 1,830 | 2,110 |
| Softening point (° C.) | INV E-712 | 48 | 54 | 46.3 | 47.1 | 48.5 |

After aging in *RTFOT

| | | | | | | |
|---|---|---|---|---|---|---|
| Penetration at 25° C. (1/10 mm) | INV E-706 | — | — | 37.8 | 41.1 | 37.6 |
| Viscosity at 60° C. (Poises) | INV E-717 | — | — | 14,500 | 11,000 | 14,400 |
| Softening point (° C.) | INV E-712 | — | — | 56.9 | 57.5 | 59.9 |
| Aging rate | INV E-717 | — | 4 | 7.92 | 6.01 | 6.82 |
| Mass loss (%) | INV E-720 | — | 0.8 | 0.31 | 0.36 | 0.34 |
| Softening point increase (° C.) | INV E-712 | — | 9 | 10.6 | 10.4 | 11.4 |
| Residue penetration (%) | INV E-706 | 50 | — | 52.6 | 55.7 | 55.3 |

*Rolling thin film oven test.

The addition of 0.25% of additive composition A-3 to Apiay asphalt does not show a significant improvement in the physicochemical properties. An increase to 0.33% of the amount of additive composition A-3 shows a marked improvement in the physicochemical properties before the aging test, meeting the required specifications. However, the values obtained in the aging test do not show a representative improvement in some of the properties evaluated. Adding more additive composition A-3 could probably help to improve the properties of the asphalt after aging.

TABLE 5
Performance of composition A-4 added to asphalt derived from heavy crude oils.
Apiay 60/70 asphalt

| | INVIAS | Specification | | Standardized | A-4 (%) | |
|---|---|---|---|---|---|---|
| Assay | standard | Minimum | Maximum | Apiay | 0.375 | 0.5 |

Before aging

| | | | | | | |
|---|---|---|---|---|---|---|
| Penetration at 25° C. (1/10 mm) | INV E-706 | 60 | 70 | 71.9 | 73 | 67.5 |
| Viscosity at 60° C. (Poises) | INV E-717 | 1,500 | — | 1,830 | 1,820 | 2,080 |
| Softening point (° C.) | INV E-712 | 48 | 54 | 46.3 | 47.7 | 48.3 |

After aging in *RTFOT

| | | | | | | |
|---|---|---|---|---|---|---|
| Penetration at 25° C. (1/10 mm) | INV E-706 | — | — | 37.8 | 37.6 | 38.3 |
| Viscosity at 60° C. (Poises) | INV E-717 | — | — | 14,500 | 11,700 | 15,200 |
| Softening point (° C.) | INV E-712 | — | — | 56.9 | 56.3 | 57.3 |
| Aging rate | INV E-717 | — | 4 | 7.92 | 6.43 | 7.31 |
| Mass loss (%) | INV E-720 | — | 0.8 | 0.31 | 0.35 | 0.31 |
| Softening point increase (° C.) | INV E-712 | — | 9 | 10.6 | 8.6 | 9 |
| Residue penetration (%) | INV E-706 | 50 | — | 52.6 | 51.5 | 56.7 |

*Rolling thin film oven test.

The addition of 0.375% of additive composition A-4 to Apiay asphalt does not show a significant improvement in the physicochemical properties evaluated before the aging test. The aging test shows an increase in the softening point that meets the requirements. In this case, increasing the content of additive composition A-4 to 0.5% significantly improves the physicochemical properties before the aging test, thus complying with the specifications. However, after aging, an increase in the aging rate is observed.

On the other hand, considering that the asphalt from the Barrancabermeja refinery has an outstanding performance to be used in the production of asphalt mixtures, a test with additive composition A-5 was carried out to check its performance. Table 6 shows the results of the performance analysis for A-5 additive composition added to the asphalt from the Barrancabermeja refinery.

TABLE 6
Performance of composition A-5 added to asphalt derived from heavy crude oils.
Barrancabermeja 60/70 asphalt

| | Specification | | Standardized | Standardized |
|---|---|---|---|---|
| Assay | Minimum | Maximum | 60/70 | 60/70 + 0.75% A-5 |

Before aging

| | | | | |
|---|---|---|---|---|
| Penetration at 25° C. ( 1/10 mm) | 60 | 70 | 65.4 | 62.2 |
| Viscosity at 60° C. (Poises) | 1,500 | — | 2,230 | 2,060 |
| Softening point (° C.) | 48 | 54 | 47.2 | 46.9 |

After aging in *RTFOT

| | | | | |
|---|---|---|---|---|
| Penetration at 25° C. ( 1/10 mm) | — | — | 38.8 | 50.9 |
| Viscosity at 60° C. (Poises) | — | — | 9,380 | 3,530 |
| Softening point (° C.) | — | — | 53.6 | 51.3 |
| Aging rate | — | 4 | 4.21 | 1.71 |
| Mass loss (%) | — | 0.8 | 0.5 | 0.4 |
| Softening point increase (° C.) | — | 9 | 6.4 | 4.4 |
| Residue penetration (%) | 50 | — | 59.3 | 75.5 |

*Rolling thin film oven test.

In this case, the aging rate changed from 4.21 to 1.71 after incorporating 0.75% of additive composition A-5. In addition, viscosity after aging was not significantly affected. Thus, the addition of additive composition A-5 shows a remarkable improvement in some of the desired physicochemical properties of the asphalt after being subjected to the aging test. For example, the penetration grade at 25° C. decreased by 11.3 tenths of a millimeter in the asphalt with additive, while in the asphalt without additive the penetration grade decreased by 26.6 tenths of a millimeter. Furthermore, viscosity increased by 1,470 Poises in asphalt with additive composition A-5, while in asphalt without additive it increased by 7,150 Poises.

On the contrary, asphalt without additive showed a significant change in the evaluated properties due to the oxidative aging process (hardening) during the aging test, while few changes were observed in the evaluated physicochemical properties after the aging test in the asphalt with additive composition A-5 of the present invention. Therefore, additive composition A-5 is an inhibitor of the aging process of the 60/70 standardized asphalt from the Barrancabermeja refinery.

### Example 3. Comparison of the Performance of Two Additive Compositions Using Various Adhesion Promoters

The effect on the performance of the additive composition of two adhesion promoters of different chemical nature was compared. For this purpose, additive compositions A-6 and A-7 were prepared according to the components presented in Table 7. In this case, additive composition A-6 was prepared with a saturated adhesion promoter of low hydrophobicity with low affinity for the hydrocarbon base oil, while additive composition A-7 was prepared with an unsaturated adhesion promoter with higher hydrophobicity, thus having more affinity for the hydrocarbon base oil.

TABLE 7
Additive compositions with adhesion promoters of different chemical nature

| | Components | | | | | |
|---|---|---|---|---|---|---|
| | | | | | Naturally | |
| Composition | Hydrocarbon | | | | occurring | |
| name | base oil | (% w/w) | Adhesion promoter | (% w/w) | resins | (% w/w) |
| Additive A-6 | 10% benzene, | 95 | aminopropyltri- | 5 | — | 0 |
| | 50% toluene, | | methoxysilane | | | |
| | 30% pentane, | | | | | |
| | 5% hexane, | | | | | |
| | and | | | | | |
| | 5% octane | | | | | |
| Additive A-7 | 10% benzene, | 95 | (3-aminopropyl)- | 5 | — | 0 |
| | 50% toluene, | | triethoxysilane | | | |
| | 30% pentane, | | (APTES) | | | |
| | 5% hexane, | | | | | |
| | and | | | | | |
| | 5% octane | | | | | |

Tables 8 and 9 show the results of the performance tests of additive compositions A-6 and A7, respectively, added to the asphalt coming from the Apiay refinery.

TABLE 8
Performance of composition A-6 added to asphalt derived from heavy crude oils.
Apiay 60/70 asphalt

| | INVIAS | Specification | | Standardized | A-6 (%) | |
|---|---|---|---|---|---|---|
| Assay | standard | Minimum | Maximum | Apiay | 0.1 | 0.15 |

Before aging

| | | | | | | |
|---|---|---|---|---|---|---|
| Penetration at 25° C. (1/10 mm) | INV E-706 | 60 | 70 | 71.9 | 65.2 | 67.8 |
| Viscosity at 60° C. (Poises) | INV E-717 | 1,500 | | 1,830 | 2,500 | 2,560 |
| Softening point (° C.) | INV E-712 | 48 | 54 | 46.3 | 48.9 | 49.3 |

After aging in *RTFOT

| | | | | | | |
|---|---|---|---|---|---|---|
| Penetration at 25° C. (1/10 mm) | INV E-706 | — | — | 37.8 | 37.06 | 36.53 |
| Viscosity at 60° C. (Poises) | INV E-717 | — | — | 14,500 | 19,300 | 20,800 |
| Softening point (° C.) | INV E-712 | — | — | 56.9 | 60.9 | 60.5 |
| Aging rate | INV E-717 | — | 4 | 7.92 | 7.72 | 8.13 |
| Mass loss (%) | INV E-720 | — | 0.8 | 0.31 | 0.28 | 0.31 |
| Softening point increase (° C.) | INV E-712 | — | 9 | 10.6 | 12 | 11.2 |
| Residue penetration (%) | INV E-706 | 50 | — | 52.6 | 56.8 | 53.9 |

*Rolling thin film oven test.

The addition of 0.1% and 0.15% of additive composition A-6 to Apiay asphalt shows a notable improvement in the physicochemical properties before the aging test, complying with the required specifications. After the aging process, the results obtained for the two proportions evaluated show values well above the specifications, including the values of the Apiay asphalt without additive. Therefore, additive composition A-6 is not appropriate as an aging inhibitor.

TABLE 9
Performance of composition A-7 added to asphalt derived from heavy crude oils.
Apiay 60/70 asphalt

| | INVIAS | Specification | | Standardized | A-7 (%) | |
|---|---|---|---|---|---|---|
| Assay | standard | Minimum | Maximum | Apiay | 0.1 | 0.15 |

Before aging

| | | | | | | |
|---|---|---|---|---|---|---|
| Penetration at 25° C. (1/10 mm) | INV E-706 | 60 | 70 | 71.9 | 60.66 | 63.6 |
| Viscosity at 60° C. (Poises) | INV E-717 | 1,500 | — | 1,830 | 2,620 | 2,560 |
| Softening point (° C.) | INV E-712 | 48 | 54 | 46.3 | 49.1 | 48.7 |

After aging in *RTFOT

| | | | | | | |
|---|---|---|---|---|---|---|
| Penetration at 25° C. (1/10 mm) | INV E-706 | — | — | 37.8 | 36.9 | 37.7 |
| Viscosity at 60° C. (Poises) | INV E-717 | — | — | 14,500 | 17,200 | 16,000 |
| Softening point (° C.) | INV E-712 | — | — | 56.9 | 60.1 | 59.1 |
| Aging rate | INV E-717 | — | 4 | 7.92 | 6.56 | 6.48 |
| Mass loss (%) | INV E-720 | — | 0.8 | 0.31 | 0.29 | 0.36 |
| Softening point increase (° C.) | INV E-712 | — | 9 | 10.6 | 11 | 10.4 |
| Residue penetration (%) | INV E-706 | 50 | — | 52.6 | 60.8 | 59.3 |

*Rolling thin film oven test.

The addition of 0.1% and 0.15% of additive composition A-7 to Apiay asphalt shows, similarly to what happens with additive composition A-6, a notable improvement in the physicochemical properties before the aging test in RTFOT, complying with the required specifications. However, after the aging process, the results obtained for the two proportions evaluated show values above the specifications and even above those of Apiay asphalt without additive. However, comparative results between the performance of additive compositions A-6 and A-7 show an improvement in the aging rate with the unsaturated adhesion promoter compared to the saturated adhesion promoter.

### Example 4. Comparison of the Performance of Two Additive Compositions Using Cured Adhesion Promoters

The behavior of the additive compositions was evaluated after a curing treatment, which consists of heating the additive between 80° C. and 100° C. for 6 h to remove as much water from the adhesion improver as possible and avoid displacement of volatile compounds or weight loss in the asphalt. In particular, the test evaluated the effect of cured adhesion improvers on the performance of the additive compositions added to a 60/70 asphalt from the Barrancabermeja refinery. To that end, the performance of additive composition A-2 (Table 1 of Example 1) was compared with a formulation of the same adhesion promoter previously cured additive composition A-8 according to Table 10.

TABLE 10
Uncured and cured additive compositions with adhesion promoters

| | Components | | | | | |
|---|---|---|---|---|---|---|
| Composition | Hydrocarbon | | Adhesion | | Naturally | |
| name | base oil | (% w/w) | promoter | (% w/w) | occurring resins | (% w/w) |
| *Additive A-8 | 40% toluene | 95 | (3-aminopropyl)- | 5 | — | — |
| | 60% heptane | | triethoxysilane | | | |
| | | | (APTES) | | | |
| Additive A-2 | 40% toluene | 95 | (3-aminopropyl)- | 5 | — | — |
| | 60% heptane | | triethoxysilane | | | |
| | | | (APTES) | | | |

*Previously cured

The performance results of the addition of additive composition A-8 are presented in Table 11.

TABLE 11
Performance of additive composition 9 added in two proportions to an asphalt derived from heavy crude oils.
Apiay 60/70 asphalt

| | INVIAS | Specification | | Standardized | Additive A-8* (%) | |
|---|---|---|---|---|---|---|
| Assay | standard | Minimum | Maximum | Apiay | 0.375 | 0.25 |

Before aging

| | | | | | | |
|---|---|---|---|---|---|---|
| Penetration at 25° C. (1/10 mm) | INV E-706 | 60 | 70 | 71.9 | 74 | 71.8 |
| Viscosity at 60° C. (Poises) | INV E-717 | 1,500 | — | 1,830 | 1,790 | 1,960 |
| Softening point (° C.) | INV E-712 | 48 | 54 | 46.3 | 45.3 | 47 |

After aging in **RTFOT

| | | | | | | |
|---|---|---|---|---|---|---|
| Penetration at 25° C. (1/10 mm) | INV E-706 | — | — | 37.8 | 41.4 | 41 |
| Viscosity at 60° C. (Poises) | INV E-717 | — | — | 14,500 | 9,810 | 10,200 |
| Softening point (° C.) | INV E-712 | — | — | 56.9 | 51.1 | 56.9 |
| Aging rate | INV E-717 | — | 4 | 7.92 | 5.48 | 5.20 |
| Mass loss (%) | INV E-720 | — | 0.8 | 0.31 | 0.27 | 0.28 |
| Softening point increase (° C.) | INV E-712 | — | 9 | 10.6 | 11.8 | 9.9 |
| Residue penetration (%) | INV E-706 | 50 | — | 52.6 | 55.9 | 57.1 |

*Using a previously cured adhesion promoter
**Rolling thin film oven test.

As shown in Table 11, some physicochemical properties of the standardized Apiay asphalt do not meet the specifications of the INVIAS standard. In this case, with the addition of 0.375% and 0.25% of additive composition A-8, no significant improvements are shown in the evaluated physicochemical properties, except for the aging rate compared to the same properties evaluated for additive composition A-2 using an uncured adhesion promoter.

An important aspect of implementing the A-8 additive composition was industrial safety, since evaporating the alcohol content also removed the moisture content, which greatly benefits the instantaneous vaporization of water at temperatures above 100° C.

### Example 5: Field Test

Field tests to demonstrate the effectiveness of the multifunctional additive compositions of the present invention were carried out with the asphalt used in the construction, rehabilitation, improvement, and routine maintenance of functional units 4, 5, and 6 that make up the Villavicencio-Yopal road corridor (Colombia). Additive composition A-5 at 1% was added to standardized Apiay 60/70 asphalt coming from the production plant located in Monterrey, Casanare, with the purpose of improving its physicochemical properties to comply with the specifications of Table 410-1, Article 410, of the INVIAS 2013 standard required for this type of application.

For the test, additive composition A-5 at 1% was added to a load of solid 60/70 asphalt from the Apiay refinery under constant agitation at a temperature between 145° C. and 160° C. so that the additive composition could react properly with the asphalt. Subsequently, the additive mixture was kept under agitation for 30 min at a temperature of not less than 140° C. in order to ensure the complete reaction of the additive with the asphalt and the homogeneity of the mixture.

Once the asphalt was additivated, the vehicle was sealed and the documents required for transporting and delivering the product to the asphalt mixture production plant were delivered. After defining the type of asphalt mixture to be prepared, the dosage of stone aggregates, the asphalt content, and the process temperatures, the asphalt mixture was produced and compacted in briquettes to verify the specifications of the asphalt mixture design.

Having verified the design specifications of the asphalt mixture, it was installed and compacted at a temperature of 140° C. as an intermediate layer for the rehabilitation and widening of the road using a metallic double tandem cylinder and a pneumatic compactor for the sealing and finishing of the asphalt layer.

Once the field application process was completed, samples were taken for performance evaluation. First, the asphalt content was determined in accordance with the Quantitative Extraction of Asphalt in Hot Mixtures for Pavements INV E-732-13 standard. Results are shown in Table 12.

TABLE 12
Determination of the asphalt content in a 1%
asphalt mixture with additive composition A-5

| | Asphalt Content | Average |
|---|---|---|
| Sample | [%] | Value |
| 1 | 4.87 | 4.91 |
| 2 | 4.96 | |

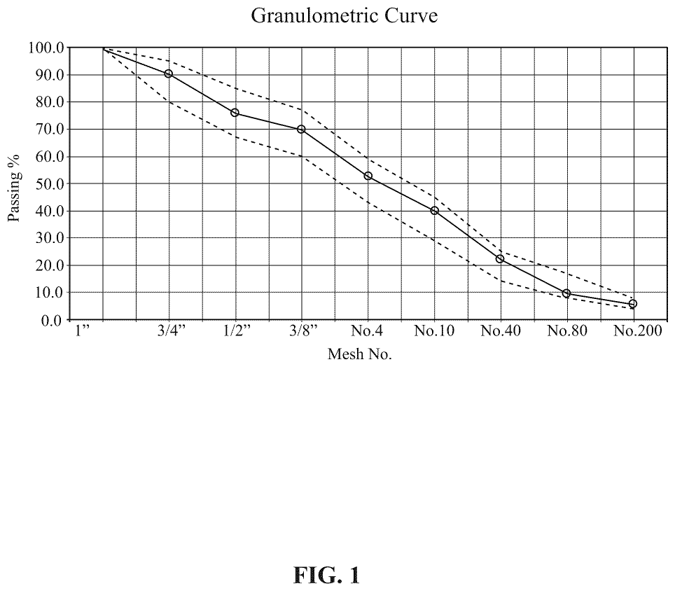

The granulometric analysis of the aggregates extracted from asphalt mixtures was performed in accordance with technical standard INV E-782-13. FIG. 1 shows the granulometry obtained from the stone material recovered in the MDC-25 hot mixture asphalt extraction test, and the behavior in terms of the requirements of Article 450-13 of the INVIAS specification.

For the evaluation of volumetric parameters, test samples were prepared according to the procedure described in the Stability and Flow of Hot Asphalt Mixtures INV E-748-13 standard. Results are shown in Table 13.

TABLE 13
Volumetric parameters of the asphalt
mixture with additive composition A-5
NT-3

| Characteristics | *Result | Specification |
|---|---|---|
| Compaction, shock/face | 75 | 75 |
| Stability, N | 14,163 | >9,000 |
| Flow, mm | 3.15 | 2-3.5 |
| Bulk density g/cm3 | 2.378 | N.A. |
| Gmm g/cm3 | 2.487 | N.A. |
| Voids with air % | 4.39 | 4-7 |
| Voids in mineral aggregates, % | 14.80 | >14 |
| Asphalt content, % | 4.91 | N.A. |
| Voids filled with asphalt, % | 70.3 | 65-75 |
| Filler/binder | 1.15 | 0.8-1.2 |
| Stability/flow, kgf/mm | 4.49 | 3-6 |

*Calculations were made based on the specifications of INV-799-13 standard.

The Tensile Strength Ratio (TSR) test was used for the evaluation of water susceptibility in compacted asphalt mixtures. Results are shown in Table 14.

TABLE 14
Water susceptibility of the asphalt
mixture with additive composition A-5

| Specification (Article 450-13) | TSR result (%) |
|---|---|
| 80 | 90.2 |

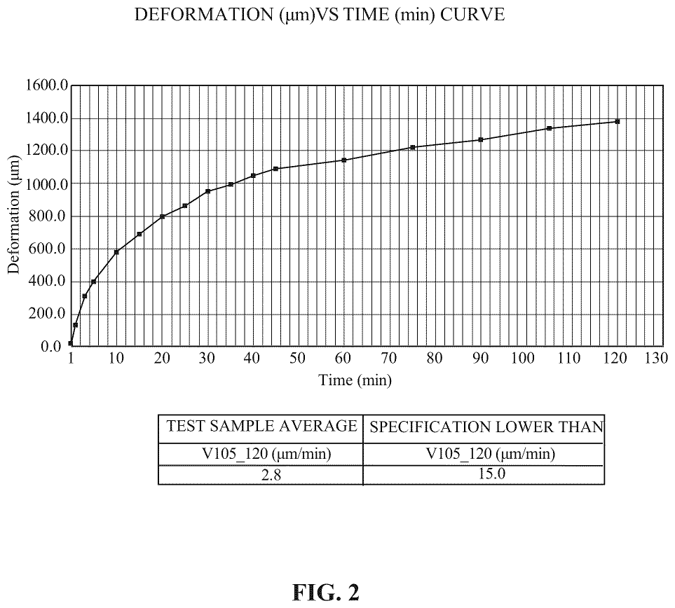

The INV E-756-13 standard was used to evaluate the resistance to track plastic deformation of asphalt mixtures. This test simulates the effect of repeated dynamic loading on an asphalt mixture and thus establishes its susceptibility to rutting. The method consists of passing a wheel over the asphalt mixture for 2 hours at a speed of 21 cycles per minute, exerting a pressure of 9.1 kgf/cm². The deformation produced is continuously monitored taking into account temperature (60° C.) and pressure conditions. Test results are shown in FIG. 2.

The dynamic moduli test of the asphalt mixture was performed following the ASHTO T-342 standard. This test determines the dynamic moduli of a sample by means of the indirect tension principle. The test is based on the application of a compressive load across the diameter of a cylindrical sample, which produces a stress on a diameter orthogonal to which the load is applied. By recording the vertical load applied and the horizontal deformation produced, the dynamic modulus (MPa) is obtained. The test allows evaluating the incidence of temperature on the dynamic behavior of the asphalt mixture by performing tests at temperatures in a set range.

For the selected samples, dynamic moduli were tested at three (3) frequencies (10-5 and 1.5 Hz) and at three (3) temperatures (5°-25°-40° Celsius), taking measurements on two sides of each sample to obtain an average result in MPa (Table 15).

TABLE 15
Dynamic moduli of the asphalt mixture
with additive composition A-5

| Temperature (° C.) | 5 | | |
|---|---|---|---|
| Frequency (Hz) | 10 | 5 | 1.5 |
| Average stress (kPa) | 754.9 | 677.4 | 569.6 |
| Average strain (μStrain) | 40.1 | 38.7 | 38.5 |
| Average phase angle (°) | 17.2 | 18.2 | 20.9 |
| Average dynamic modulus (Mpa) | 18,706 | 17,440 | 14,784 |
| Temperature (° C.) | 25 | | |
| Frequency (Hz) | 10 | 5 | 1.5 |
| Average stress (kPa) | 216.7 | 190.0 | 139.0 |
| Average strain (μStrain) | 35.2 | 37.5 | 36.3 |
| Average phase angle (°) | 30.1 | 29.0 | 32.1 |
| Average dynamic modulus (Mpa) | 5,993 | 5,027 | 3,826 |
| Temperature (° C.) | 40 | | |
| Frequency (Hz) | 10 | 5 | 1.5 |
| Average stress (kPa) | 77.4 | 63.7 | 49.0 |
| Average strain (μStrain) | 37.1 | 35.4 | 35.7 |
| Average phase angle (°) | 35.1 | 33.2 | 34.9 |
| Average dynamic modulus (Mpa) | 2,087 | 1,799 | 1,372 |

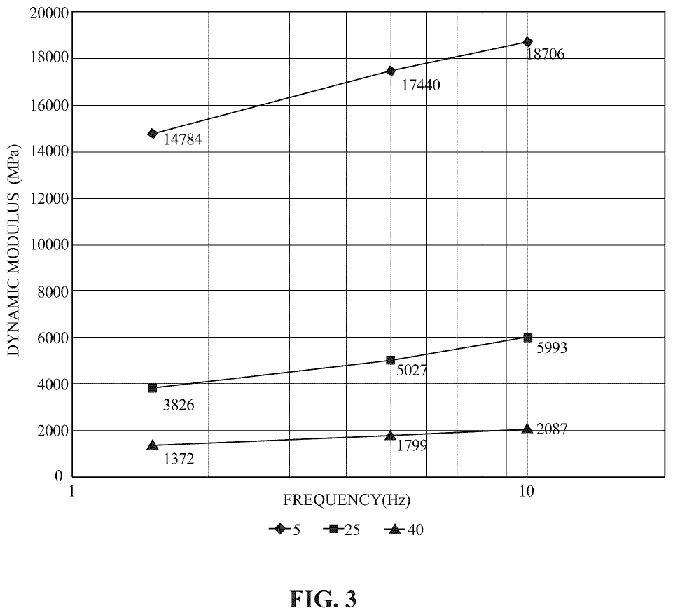

FIG. 3 shows the behavior of the average dynamic modulus as a function of frequency and temperature for the asphalt mixture with additive composition A-5. According to the results, the asphalt mixture having 1% additive composition A-5 has an asphalt content of 4.9%, wherein the stone material obtained from the extraction complies with granulometric range provided in Article 450-13 of INVIAS-13 specification.

In the verification of the volumetric parameters, it was found that all the values meet the specifications of table 450-10 for the design criteria for hot asphalt mixtures in accordance with Article INVIAS INV E-450-13. Furthermore, the plastic deformation resistance test showed a deformation rate of 2.8 μm in the 105 to 120 minute range, a result that is within the maximum rate allowed according to Table 450-11 of Article 450-13 of the specification, that is, 15 μm. This value is related to the outstanding cohesion of the asphalt mix obtained after adding the additive composition, shown in the evaluation result of water susceptibility (90.2%) of compacted asphalt mixes using the Tensile Strength Ratio (TSR) test.

Considering the above, it can be stated that the industrial technical test is successful and the use of the multifunctional additive compositions of the present invention allow the properties of the asphalt to be improved, thus complying with the specifications required by various regulations.

1. An asphalt additive composition comprising:
hydrocarbon base oil from 60% w/w to 95% w/w;
adhesion promoter from 1% w/w to 10% w/w; and
naturally occurring resins from 10% w/w to 20% w/w.

2. The asphalt additive composition according to claim 1, wherein the hydrocarbon base oil is selected from the group comprising light, medium, and heavy paraffinic distillate compounds and aromatic compounds.

3. The asphalt additive composition according to claim 2, characterized in that the hydrocarbon base oil comprises paraffinic compounds from 30% w/w to 50% w/w or aromatic compounds from 20% w/w to 50% w/w or mixtures thereof.

4. The asphalt additive composition according to claim 1, characterized in that the adhesion promoter comprises aromatic, amine, acrylic, and straight or branched chain organosilane derivatives and mixtures thereof.

5. The asphalt additive composition according to claim 1, characterized in that the naturally occurring resins comprise tannins, terpenes, and rosin.

6. The asphalt additive composition according to claim 1, comprising non-aggregate additives from 0.1% w/w to 5% w/w.

7. The additive composition according to claim 6, wherein additives are selected from the group comprising low vapor pressure fluxing agents, oxidation inhibitors, rheology modifiers, surfactant homogenizers, and mixtures thereof.

8. The additive composition according to claim 1, characterized in that it comprises, before aging, a penetration grade at 25° C. between 40 and 100 ( 1/10 mm); viscosity at 60° C. between 1,000 and 8,000 (Poises); a softening point between 45 and 54 (° C.); and, after aging, a penetration grade at 25° C. between 30 and 60 ( 1/10 mm); viscosity at 60° C. between 3,000 and 10,000 (Poises); a softening point between 53 and 60 (° C.); an aging index between 1 and 4; a mass loss between 0.1 and 1(%); an increase in the softening point between 1 and 8 (° C.); and a penetration of the residue between 46 and 60(%).
